(19) United States
(12) Patent Application Publication
(10) Pub. No.: US 2009/0048948 A1
(43) Pub. Date: Feb. 19, 2009

(54) APPARATUS, AND ASSOCIATED METHOD, FOR MAINTAINING AN ASSET REPOSITORY

(75) Inventors: MING-JYE JACK PAN-CHEN, SAN JOSE, CA (US); SABARIDAS DEVADOSS, SAN JOSE, CA (US)

Correspondence Address: DOCKET CLERK, P.O. BOX 12608, DALLAS, TX, 75225, US

(73) Assignee: ELECTRONIC DATA SYSTEMS CORPORATION, PLANO, TX (US)

(21) Appl. No.: 11/838,795

(22) Filed: Aug. 14, 2007

(51) Int. Cl. G06Q 10/00; G06F 17/30; G06F 17/40

(52) U.S. Cl. 705/28

(57) ABSTRACT

Apparatus, and an associated method, for updating and reconciling asset repositories. A user event, generated by, or otherwise associated with, an asset is detected. The operations event identifies characteristics of the asset with which the event is associated. The information is compared with repository-stored information. If comparison indicates dissimilarity with the newly-obtained information and the repository-stored information, the contents of the asset repository are updated to indicate the updated information.

The present invention relates generally to a manner by which to maintain an asset repository with updated information regarding assets of an enterprise, such as IT (Information Technology) assets of an IT organization. More particularly, the present invention relates to apparatus, and an associated method, by which to ascertain updated information related to an asset by analyzing information contained in alerts sent by the assets and updating, or otherwise reconciling, repository information associated with the asset.

Outdated information stored at an asset repository is replaced with up-to-date information contained in the alert. And, as alerts are generated and sent pursuant to normal asset operation, the updating and reconciliation of the asset information is permitted to be carried out without costly changes to an existing infrastructure.

### BACKGROUND OF THE INVENTION

The use of computers is widespread throughout society. Their availability and use is a practical necessity of everyday functioning of many business, and other, enterprises. With advancements in computer processing, and other, technologies, the costs of computer processing devices have fallen while, at the same time, their processing capabilities have increased. Increased affordability of the computer processing devices together with their increased performance have caused yet further increase in the use of, and the reliance upon, computer processing devices.

Additionally, discrete, computer processing devices, herein referred to generally as IT assets, are connected together by way of a communication network, such as a local area, or wide area, network. The discrete, computer processing devices, so-connected, are able variously to send and to receive information. Wireless links are sometimes also provided, permitting the interconnection of a computer processing device by way of a radio link. Again, also, the device is capable variously of sending and receiving data. Howsoever interconnected, the ability to communicate between different ones of the devices permits work tasks to be performed at the different ones of the processing devices and the results of such operations subsequently to be communicated elsewhere. Large-scale enterprises benefit significantly from the ability to have processing operations performed at disparate locations for subsequent congregation at one or more centralized locations. The discrete, computer processing devices oftentimes utilize commercial software products, i.e., software developed elsewhere and sold to, or licensed to, the enterprise. Sometimes, the software products are of differing versions with different versions of the same software product installed at different ones of the computer processing devices. Likewise, different ones of the computer processing devices might well have different hardware constructions. Over time, operating personnel at different ones of the discrete locations at which the computer processing devices are located might well update either the hardware architecture of the processing devices or the software resident thereat.

Enterprise personnel, herein referred to as personnel of an IT (Information Technology) organization of the business, or other, enterprise are sometimes encharged with overseeing and managing the IT assets, collectively, the IT infrastructure, of the enterprise. Amongst the management and oversight activities typically required of the IT, or other, organization is maintenance of an inventory of the computer processing devices, i.e., assets, of the organization. Especially when the enterprise is a large-scale enterprise, the maintenance of the inventory becomes a challenging endeavor. Due to the discrete positioning at different locations of computer processing devices and corresponding local physical control over the asset, updated software or updates to the architecture might be carried out without the knowledge of the IT personnel or for any of various other reasons, the inventory of the assets of the enterprise are not properly updated.

While time-consuming or costly procedures can be implemented better to maintain an accurate inventory of the assets, budgetary and manpower constraints limit the implementation of inventory asset management.

Accordingly, there remains a need to provide better maintenance of asset inventory information, such as information maintained at an asset repository.

It is in light of this background information related to management of IT, or other, assets that the significant improvements of the present invention have evolved.

### SUMMARY OF THE INVENTION

The present invention, accordingly, advantageously provides apparatus, and an associated method, by which to maintain an asset repository with updated information regarding assets of an enterprise, such as the IT assets of an IT organization.

Through operation of an embodiment of the present invention, a manner is provided by which to ascertain updated information related to an asset by analyzing information contained in alerts sent by the assets and updating, or otherwise reconciling, conflicting information with corresponding information stored at the asset repository.

By making use of alerts that are generated pursuant to regular operation of computer processing devices, changes need not be made to existing operation of the computer processing devices forming the assets of the enterprise. Up-to-date information is contained in the alerts, and such information is used to update the repository-stored information associated with the assets.

In one aspect of the present invention, alerts, are generated during conventional operation of the assets of an enterprise, such as an IT organization of a business, or other, enterprise. Detection is made, e.g., by an alerts processing engine that is positioned, such as through connection to a wired, or radio, network to which the assets are also connected. The detector detects the alerts, which typically include key attributes as part of the alert message. The key attributes include, for instance, attributes of the asset at which the alert originates, or otherwise pertains. The key attributes include, for instance, hardware characteristics of the associated asset, software products installed at the asset, the versions of the software products, as well as any other appropriate attribute or characteristic of the asset.

In another aspect of the present invention, information stored at an asset repository and associated with the asset related to the alert is retrieved. The asset repository is, e.g., a local repository or, e.g., is a central device repository. In one implementation, the local device repository is accessed. And, if no information associated with the asset related to the alert is located in the local device repository, then the central device repository is accessed to retrieve the associated information therefrom. In such an implementation, a determiner determines whether the local device repository contains the associated information. If determination is made that the information is not contained at the local device repository, signaling is generated and sent to the central device repository to access the contents thereof and to retrieve the requested contents therefrom.

In another aspect of the present invention, a comparison is made between the alert-contained information and corresponding repository-retrieved information. If the comparison indicates that the information corresponds, then the stored information is current, i.e., up-to-date. The stored contents, stored at the asset repository, therefore need not be altered. Conversely, if comparison indicates the values of the information to be dissimilar, the stored contents of the repository are considered to be out-of-date, i.e., not current. That is to say, if there is a discrepancy between the alert-contained information and the retrieved information, than the retrieved information is considered to be stale.

In another aspect of the present invention, upon comparison of the alert-contained and retrieved values and determination that the values are dissimilar, a decision is made whether to update the stored contents. In one implementation, the decision is automatically made. That is to say, upon determination of the dissimilarity, the asset repository is automatically updated with the updated information. In another implementation, manual selection is made of whether to update the stored contents. That is to say, semi-automatic operation is provided in which an operator, such as a monitoring engineer, of the alerts processing engine is provided with an indication of the comparison results, and the monitoring engineer selects whether the repository is to be updated with the updated information.

In another aspect of the present invention, when semi-automatic operation is provided, results of the comparison are displayed at a user display, such as a computer-terminal display that is monitored by a monitoring engineer. The monitoring engineer, or other appropriate personnel, upon viewing the display of the comparison results, elects whether to update an appropriate asset repository with the updated information. Upon election, an input is caused to be generated to cause the updating of the information. The input is provided, e.g., by way of actuating actuation keys of a computer-terminal keyboard. By updating the stored information with the updated information, the asset repository is reconciled with the updated information, the asset repository is reconciled with the information contained in the key attributes of the detected alert.

A manner is thereby provided by which to provide for the intelligent extraction of relevant asset information from an event as it is received by an alert management infrastructure. Use of the asset information is made to update asset repositories, either automatically or semi-automatically while also establishing a process related to reconciliation of the asset repositories. That is to say, reconciliation is further made, if needed, between the local device repository and the central device repository.

In another aspect of the present invention, a diary is maintained of each update to the asset repository. The diary is later accessible for purposes of organization audits, or the like. Whether automatically generated, or generated responsive to semi-automatic operation, the changes to the asset inventory identify updates to the organizational infrastructure. The audit results provide better for analysis of asset capabilities and needs.

In these and other aspects, therefore, apparatus, and an associated method is provided for facilitating maintenance of an information technology, IT, repository that stores asset information relating to an enterprise IT asset. An operations event detector is configured to detect an operations event associated with an IT asset. A comparator is configured to compare operations-events-contained asset information with repository-stored asset information. An updater is configured selectably to update the repository-stored asset information responsive to comparison made by the comparator.

A more complete appreciation of the scope of the present invention and the manner in which it achieves the above-noted and other improvements can be obtained by reference to the following detailed description of presently-preferred embodiments taken in connection with the accompanying drawings, which are briefly summarized below, and by reference to the appended claims.

### BRIEF DESCRIPTION OF THE DRAWINGS

FIG. 1 illustrates a functional block diagram of an arrangement of computer assets connected together with apparatus of an embodiment of the present invention that updates and reconciles asset repositories.

FIG. 2 illustrates an exemplary operations event forming an alert generated during operation of the arrangement shown in FIG. 1.

FIG. 3 illustrates a message sequence diagram representative of signaling generated during exemplary operation of an embodiment of the present invention.

FIG. 4 illustrates a method flow diagram representative of the method of operation of an embodiment of the present invention.

### DETAILED DESCRIPTION

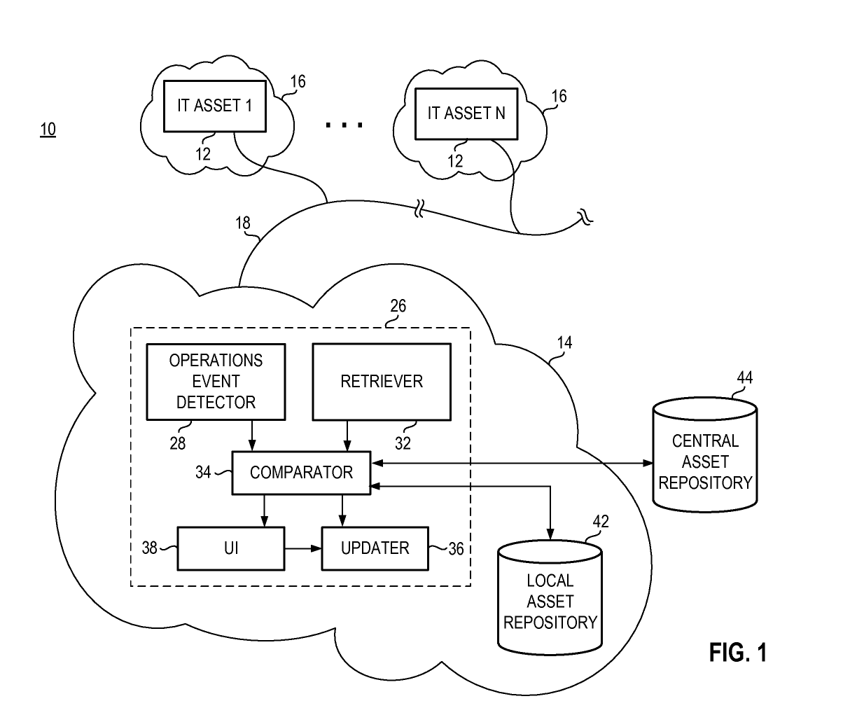

Referring first to FIG. 1, an exemplary arrangement, shown generally at 10, includes a plurality of assets 12 formed computer processing devices, or other enterprise assets, that are placeable in communication connectivity with a monitoring location 14. In the exemplary arrangement shown in FIG. 1, the assets 12 are positioned at remote locations 16, remote from the monitoring location 14 and connected to the monitoring location by way of a Wide Area Network (WAN) connection 18 or other communication link. The exemplary arrangement comprises the IT (Information Technology) assets of an IT organization, such as the IP department of a multi-site business, or other, enterprise. More generally, the arrangement is representative of any of various arrangements of enterprise assets that are placeable in communication connectivity with a monitoring location.

As mentioned previously, a common challenge of IT, or other, personnel encharged with the inventory maintenance of the computer, and other, assets of the organization is the need to maintain an up-to-date inventory of the assets of the organization. As the assets are sometimes updateable, both in hardware architecture and installation of software products, the inventory, which is to take into account the software and hardware capabilities of the assets, must be updated to reflect the changes to the assets. Conventional mechanisms by which to maintain the inventory of the assets in up-to-date condition have generally been inadequate, particularly when costs need to be constrained.

Pursuant to an embodiment of the present invention, the arrangement 10 shown in FIG. 1 includes apparatus 26 of an embodiment of the present invention that facilitates maintenance of an asset repository at which an up-to-date listing forming the inventory of the assets is maintained. The apparatus is formed of functional elements, implementable in any desired manner, including, for instance, by algorithms executable by processing circuitry. The apparatus is here shown to include an operations event detector 28, a retriever 32, a comparator 34, an updater 36, and, selectably, a User Interface (UI) 38. The apparatus is positioned in communication connectivity with the assets 12, here by way of the wide area network connection. The apparatus is further positionable in communication connectivity with a local device repository 42 and a central device repository 44.

The repositories 42 and 44 are operable, amongst other things, to maintain inventories of the organizational assets, here the IT assets 12. The local device repository is here positioned at the monitoring location 14 while the central device repository is positioned at a remote location 16.

The assets 12 generate alerts at selected times or intervals, in conventional manner. The alerts that are generated are communicated, here upon the WAN communication link 18. The alerts include key attributes that identify the asset characteristics, such as hardware component parts and software-product installations thereon.

The detector 28 detects the alerts generated by the assets 12 and extracts values of the information contained therein. The extracted values are provided to the comparator 34.

The retriever 32 operates to retrieve data stored at the repositories 42 and 44. The retrieved information includes information, if available, corresponding to the information extracted from the alerts detected by the detector 28. The retrieved information is also provided to the comparator 34. In one implementation, the retriever includes a determiner that determines whether the information is stored at the local repository 42. If so, the information is retrieved therefrom. If the information is unavailable at the local repository, then the retriever attempts to retrieve the information from the central device repository 44.

The detected values and the corresponding retrieved values are compared by the comparator and results of the comparison are provided to, here, both an updater 36 and to a User Interface (UI) 38. The updater operates to update the repository 42 or 44 with updated information associated with the asset. In one implementation, even if the informational content associated with the address is not updated, the time at which the alert is sent, or comparison is made, is stored at the repository. If new information is contained in the alert that has previously not been stored at the repository, the updater, in one implementation, further selects whether to, and causes the, additional information to be stored at the repository. The updater further acts to reconcile the contents of the data stored at the local-device and central-device repositories 42 and 44. Thereby, reconciliation is made both to reconcile the stored contents of the asset repository with the updated information contained in the alert as well as also to reconcile the contents of the separate data bases of the asset repositories 42 and 44. If additional repositories are utilized, additional reconciliation with the additional data bases is performed.

In one implementation, the updater operates automatically responsive to results of the comparisons made by the comparator. In an alternate implementation, semi-automatic operation is provided. That is to say, monitoring engineer monitors a user display of the user interface 38. The results of the comparison are displayed at the display device, providing the monitoring engineer with the opportunity to elect whether to cause updating to be performed. Election made by the monitoring engineer is entered by way of an input actuator of the user interface, such as appropriate actuation of actuation keys of an actuation keyboard. And, indications of the election are provided to the updater to cause appropriate operation thereof. Updating of the stored information at the repository is then carried out. Subsequent reconciliation of the separate asset repositories is alternately carried out automatically or, also, responsive to election by the monitoring engineer.

Thereby, by making use of alerts that are conventionally generated by the assets 12, an up-to-date inventory of the assets of the organization is readily maintained. The inventory is retrievable for any desired purpose, including, for instance, for audit purposes to audit the assets of the organization.

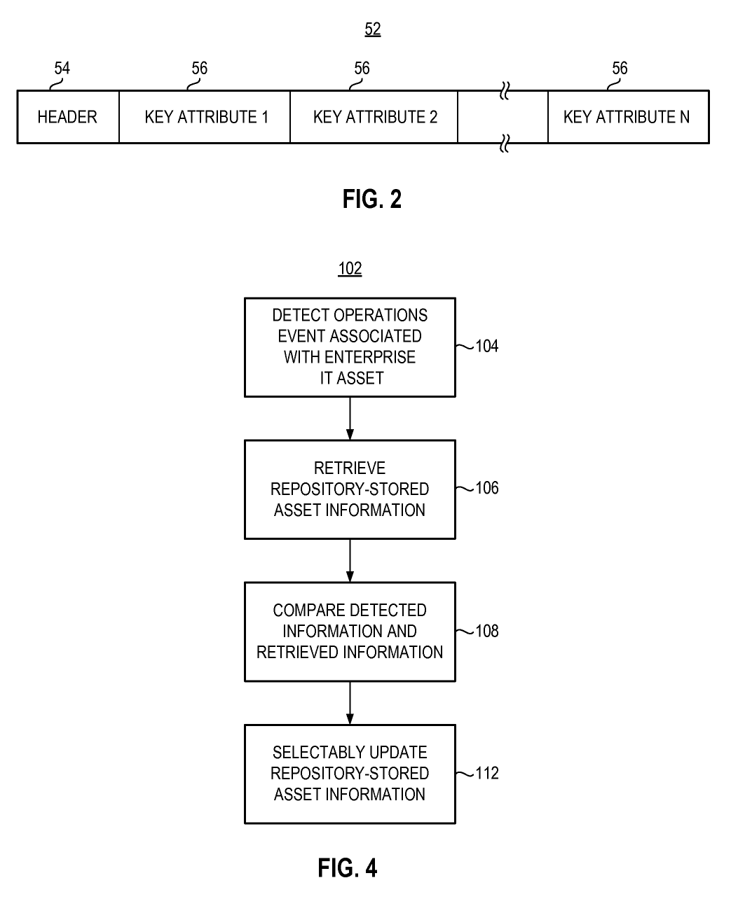

FIG. 2 illustrates an exemplary alert 52, such as that generated by an asset 12 shown in FIG. 1. The alert here includes a header part 54 and a plurality of key attributes 56. The key attributes are of values that identify attributes of the asset with which the alert is associated. The attribute identifies, for instance, hardware components of the asset and software products, and their associated versions, that are installed or otherwise operable at the asset.

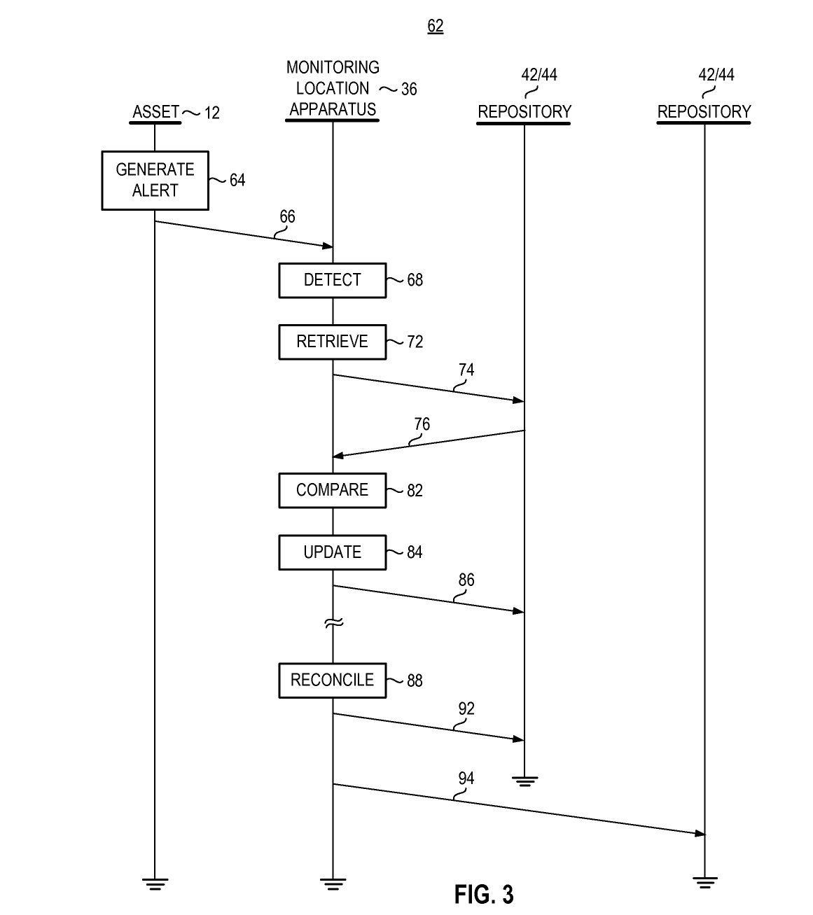

FIG. 3 illustrates a message sequence diagram, shown generally at 62, representative of signaling generated during operation of an embodiment of the present invention, here an implementation corresponding to the arrangement 10 shown in FIG. 1. The signaling provides for the maintenance of an asset repository in use of operations events that are generated by assets of which information associated therewith is stored at the asset repository.

Here, an asset 12 generates, pursuant to its operation, an alert indicated by the block 64. When the asset forms a server, an alert is generated, for instance, when a server fault occurs. The alert is communicated, indicated by the segment 66, and delivered to the apparatus 36 positioned at a monitoring location.

The alert is detected, indicated by the block 68, and the information contained in the alert is extracted therefrom. The information includes, for instance, key attributes of the asset. And, as indicated by the block 72, repository stored data associated with the alert is retrieved. Retrieval is carried out, indicated by the segment 74 and 76 to request access to the associated data stored at a repository 42-44 and retrieval of the contents, once accessed.

A comparison is made, indicated by the block 82, between the retrieved information and the detected information. If the results of the comparison indicate the similarities, a decision is made to update, indicated by the block 84, the data stored at the repository. Updating is carried out, indicated by the segment 86.

In the illustrated implementation, further reconciliation, indicated by the block 88 is carried out. Reconciliation is here further carried out between separate asset repositories through signaling indicated by the segments 92 and 94 to separate asset repositories 42/44.

FIG. 4 illustrates a method flow diagram, shown generally at 102, representative of the method of operation of an embodiment of the present invention. The method facilitates maintenance of an information technology, IT repository that stores asset information relating to an enterprise IT asset.

First, and as indicated by the block 104, detection of an operations event associated with the enterprise IT asset is made. Then, and as indicated by the block 106, repository-stored asset information is retrieved that is associated with the enterprise IT asset. Then, and as indicated by the block 108, comparison is made between operations-events-contained asset information and the retrieved, repository-stored asset information. And, as indicated by the block 112, the repository-stored asset information is selectably updated responsive to the comparison between the operations-events-contained asset information and the repository-stored asset information.

Thereby, through operation of an embodiment of the present invention, a manner is provided by which to obtain, and maintain, up-to-date information associated with organizational assets. The information is obtained by analysis of operations events, such as alerts, generated pursuant to conventional operation of an asset. Up-to-date information is available for, e.g., audit or other purposes.

Presently preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. Apparatus for facilitating maintenance of an information technology, IT, repository that stores asset information relating to an enterprise IT asset, said apparatus comprising:
an operations event detector configured to detect an operations event associated with the enterprise IT asset;
a comparator configured to compare operations-events-contained asset information with repository-stored asset information; and
an updater configured selectably to update the repository-stored asset information responsive to comparison made by said comparator.

2. The apparatus of claim 1 wherein the operations events detector comprises an enterprise IT asset-generated alert.

3. The apparatus of claim 2 wherein the enterprise IT asset-generated alert comprises an alert string containing key attributes and wherein said comparator is configured to compare values of the key attributes with the repository-stored asset information.

4. The apparatus of claim 1 wherein said comparator comprises an alerts processing engine.

5. The apparatus of claim 4 wherein the repository-stored asset information comprises local-repository-stored asset information stored local to the alerts processing engine.

6. The apparatus of claim 4 wherein the repository-stored asset information comprises central-repository-stored asset information stored remote from the alerts processing engine.

7. The apparatus of claim 4 wherein the repository-stored asset information comprises, if available, local-repository-stored asset information stored local to the alerts processing engine. And, if unavailable, central-repository-stored asset information stored remote from the alerts processing engine.

8. The apparatus of claim 7 wherein the alerts processing engine comprising said comparator further comprises a determiner configured to determine whether the local-repository-stored asset information is available.

9. The apparatus of claim 4 wherein the alerts processing engine comprising said comparator is configured to provide semi-automatic comparison of the operations-events-contained asset information with the repository-stored asset information.

10. The apparatus of claim 9 further comprising an update selector configured semi-automatically to cause said updater to update the repository-stored asset information.

11. The apparatus of claim 4 wherein the alerts processing engine comprising said comparator is configured to provide automatic comparison of the operations-events-contained asset information with the repository-stored asset information.

12. The apparatus of claim 1 wherein update of the repository-stored asset information by said updater comprises overwriting of the repository-stored asset information with the operations-events-contained asset information determined by said comparator to be dissimilar.

13. A method for facilitating maintenance of an information technology, IT, repository that stores asset information relating to an enterprise IT asset, said method comprising the operations of:
detecting an operations events associated with the enterprise-IT asset;
comparing operations-events-contained asset information with repository-stored asset information; and
selectably updating the repository-stored asset information responsive to comparison made by said comparator.

14. The method of claim 13 wherein the operations event detected during said operation of detecting comprises an alert string containing key attributes.

15. The method of claim 13 further comprising the operation, prior to said operation of comparing, of accessing the repository-stored asset information.

16. The method of claim 13 further comprising the operation of displaying results of comparisons made during said operation of displaying on a user display.

17. The method of claim 16 further comprising the operation of manually selecting whether to update the repository-stored asset information.

18. The method of claim 13 wherein said operation of updating is automatically performed responsive to comparison made during said operation of comparing that indicate dissimilarity between the operations-events-contained asset information and the repository-stored asset information.

19. The method of claim 13 further comprising the operation of maintaining a record identifying updates made during said operation of updating.

20. An IT, information technology, asset repository updater and reconciler for an enterprise, said IT asset repository updater and reconciler comprising:
an alert detector configured to detect an asset-generated alert that contains asset information;
a discrepancy detector configured to detect discrepancies between the asset information contained in the asset-generated alert and corresponding repository-stored information; and
a repository updater configured to update the repository-stored information when discrepancy is detected by said discrepancy detector.
